(19) United States
(12) Patent Application Publication
(10) Pub. No.: US 2017/0212051 A1
(43) Pub. Date: Jul. 27, 2017

(54) Glass Screen Protector with Adhered Print, Process for Authenticating a Maker of Glass Screen Protector with Ultraviolet Ink, and Screen Protector for Decorating a Powered-off Display

(71) Applicant: Carlos Magno De Lacerda, Aventura, FL (US)

(72) Inventor: Carlos Magno De Lacerda, Aventura, FL (US)

(21) Appl. No.: 15/372,388

(22) Filed: Dec. 7, 2016

Related U.S. Application Data
(60) Provisional application No. 62/337,753, filed on May 17, 2016.

(51) Int. Cl. G01N 21/64; B41M 3/14; G06F 1/16; B32B 7/12; B32B 17/06

(52) U.S. Cl. CPC G01N 21/6447; B32B 7/12; B32B 17/064; G06F 1/1601; B41M 3/144; B32B 2255/28; B32B 2307/422; B32B 2451/00; B32B 2457/20; G01N 2201/061

(57) ABSTRACT

A glass screen protector with a logo printed beneath the exterior surface of the glass protects an underlying screen and displays the logo for decorative and branding purposes. In addition, a method is taught for printing on the glass screen protector. The printable glass, and method are created through layering method combine multiple layers in order to create a uniform printable glass, absent bubbling, with the printed medium subsurface. An additional polyethylene terephthalate/optically clear adhesive/printed logo laminate is included behind a glass layer to provide a screen protector with a custom printed logo that does not interfere with touchscreen use or lead to bubbling in the screen protector. A printed logo made of pigments that are viewable in visible light can be placed over a part of a device's screen that is not used to display information from the device. A printed logo of ultraviolet visible ink that is transparent in visible light can be used to authenticate a screen protector as being made by a particular manufacturer. A layer of one-way printing can be used to create a screen protector that shows the one-way printing when the protected screen is not in use and that shows the screen that is unobstructed when the protected screen is powered on and in use.

### CROSS-REFERENCE TO RELATED APPLICATIONS

This application claims the benefit of U.S. Provisional Application No. 62/337,753, filed May 17, 2016, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

The invention relates to screen protectors for electronic displays and methods for making glass screen protectors.

Description of the Related Art

Glass screen protectors are used to protect electronic displays in devices such as smart phones and tablet computers.

Traditional methods for printing logos and other matter on glass prescribe only to exterior surface printing. By printing on the exterior surface, the print is exposed. This exposure typically causes the printed material to become worn, chipped, or scraped from the glass. When worn, what was once readable when originally printed, is no longer discernable. After the printed material is no longer discernable, the user of the printed material must administer new printed material to replace the worn out material. This is not optimal due to the high use of glass materials today, including use in mobile cellular phones.

Use of printed medium on commonplace items is widely used as promotional items. The writing on these promotional items is the key component of the promotional item. When the writing becomes worn, the promotional item loses value. Once the writing is no longer readable by persons viewing the item, the item is no longer useful as a promotional tool.

Users of mobile phones today seek personalization. These users often apply cases and other accessories to both protect their device and to create a sense of uniqueness.

Touchscreens involve additional challenges to printing on the exterior surface of a screen protector. The typical mobile cellular phone today includes a touch screen. These touch screen are often exposed to impact. So, owners look to protect their screens by applying protective glass to the surface. Ordinarily, the external surface protection is unable to maintain printable material due to the amount of wear and tear to which the surface is exposed. Traditional printable efforts do not allow for subsurface printing and thus limit the ability to have enduring printed material on the surface of these screens.

Currently, there are no methods available to allow for successful printing of material beneath the glass screen protector. When a logo is printed on an interior surface of the glass in a screen protector, bubbling around a printed area on an interior surface of the glass may occur. In addition, the added thickness of the printing below the surface of the glass causes the portion of the glass containing the printed material to be raised relative to the rest of the glass surface. This can create an annoyance to the user because the glass screen protector no longer feels smooth. In addition, when the glass is uneven, the glass can become worn at an increased rate. A touch by a user on the glass screen connector may not be conducted to the underlying touchscreen when the printed area is bubbled. The bubbled printed area can block the view of the underlying touch screen.

If the glass is suffering from bubbling, that area is raised above the rest of the glass surface. When this glass is adhered to the surface of a cellular phone, the area that is raised will rub against the objects more often than it would had bubbling not been present.

### BRIEF SUMMARY OF THE INVENTION

The invention encompasses a glass screen protector with printing beneath the exterior glass surface.

The instant invention relates to a printable glass, and method of manufacture that allows for printable material (i.e. print) to be adhered below the surface of the glass. The instant invention takes the printable material that would be adhered to the surface and exposed to the elements, below the surface through a very developed technique.

An object of the invention is to allow for printed material to be adhered to the layering of the glass in order to remove the printed material from the surface area, in order to keep the printed material free from the wear and tear that would occur had the printed material been printed to the surface of the glass.

A further object of the invention is to provide a screen protector that is printed with a logo that brands or promotes the person or business that gave the screen protector. Screen protectors are an important means for protecting electronic device screens, yet many people do not purchase screen protectors. However, when a device is owner is given a screen protector, the device owner is likely to use it for its protective qualities even when a logo or promotional message of the giver is printed on the screen protector. The value of claiming unused areas of a smartphone screen for promotion is significantly higher than other items when one considers how many often and how much time most smartphone owners spend looking at their smartphone screens.

A further object of the invention is to add a customization to a smart phone that allows the owner to reflect their personality. For example, a smartphone owner who supports a given sports team can buy a screen protector with the sports team's logo printed on the screen protector. Names, messages, and other content selected by the end user can be printed on the screen protector.

The printable glass provides a way to adhere printed material to glass, below the surface, using the following layering technique. First, the glass is tempered for a sufficient duration to allow for full finishing of tempering. Next, the logo (i.e. print) is printed on the back (i.e. the interior surface) of the glass. The ink is heated and cured. Once completed, a first layer is used to cover the logo and the back of the glass. This first layer is typically an optically clear adhesive (OCA) layer. The optically clear adhesive is the glue used primarily to adhere the glass to the next interior layer. Anti fingerprint oil is then applied to the exterior surface of the glass. Finally, a second layer is applied beneath the first layer. This second layer is typically composed of Polyethylene Terephthalate (PET). The Polyethylene Terephthalate is a thermoplastic resin of the polyester family. Polyethylene Terephthalate may exist both as an amorphous (transparent) and as a semi-crystalline polymer. In the preferred embodiments the Polyethylene Terephthalate is amorphous. The second layer releaseably adheres the glass screen protector to the underlying screen that is to be protected.

To prevent bubbling, the first layer can include a cutout. The cutout complements the shape of the printed area. Because the printed area is nested in the first layer, the total thickness at the printed area does not exceed the thickness of the first layer.

It is an object of the present invention to create a printable glass for use as a screen protector for devices, including but not limited to mobile cellular devices. The present invention allows for logos and other printed material to be applied on the interior of the glass surface.

During the development of the screen protector with printed logos experiments were conducted to test how to make a screen protector that can include a printed logo that still provides a smooth touchscreen without bubbles trapped within the laminate layers.

Printing a logo directly on the inner surface of a glass layer did succeed at creating a screen protector in which the logo did not interfere with the use of the touchscreen and did not triturate during use. However, in screen protectors with logos merely printed directly on the inner surface of the glass, air bubbles appeared beneath and around the printed logo.

Printing a logo directly on a surface of a PET layer where the logo only covered a portion of the PET layer produced a screen protector in which the logo did not interfere with the use of the touchscreen and did not triturate during use. However, the resulting outer surface of the glass felt uneven to users of the touchscreen, which is higher above the printed logo.

A screen protector was made in which a logo was printed on the PET layer. Then the printed logo was covered with an OCA layer. The outer surface of the resulting screen protector still felt uneven to users. That is, the area above the printed logo felt thicker to users as the users moved their fingers over the logo. In addition, bubbling still occurred around the logo.

From the various attempts, it was discovered that choosing inks that provided sufficient coverage (i.e. opacity) with the thinnest application produced the best screen protectors. However, inks that provide better coverage are more costly than inks that provide lesser coverage. Accordingly, the improvement from thinner ink must be balanced with the cost of purchasing better ink.

A first workable solution involved using high quality inks in conjunction with thicker than usual OCA layers to produce a smooth, bubble-free screen protector. Inks were chosen based on the inks ability to cover sufficiently with the least (i.e. thinnest) amount of ink on the glass. Then, a thicker than usual OCA layer could be applied over the printed logo. The resulting screen protector did not bubble and felt smooth when used.

According to a second solution, a screen protector that met the objects of the invention was produced. Again, inks were chosen based on the inks ability to cover sufficiently with the least (i.e. thinnest) amount of ink on the class. Next, a portion of the OCA layer that overlays the printed logo was removed. The resulting printed logo and carved-out OCA layer produced an overall layer that had one height and that did not bubble.

According to a third solution, a screen protector with an additional PET layer was used. In the third solution, a logo was printed on an inner surface of a PET layer. Next, a second PET layer with a traditional OCA layer on its outer surface was added. The outer surface of the second OCA layer is adhered to the printed logo and the inner surface of the first PET layer. The resulting structure did not require modification to standard OCA layer/PET layers. The resulting screen protector felt smooth to users and did not produce bubbles.

Ultraviolet visible ink can be included in the printed layer. Ultraviolet visible ink is ink that includes pigments that fluoresce when exposed to ultraviolet light. Ultraviolet visible ink is transparent (i.e. invisible) when exposed to visible light.

Including ultraviolet visible ink in the printed layer enables authentication of a maker (i.e. manufacturer) of a screen protector. When a potential-customer, investigator, or manufacturer wants to authenticate that a given glass screen protector is actually made by a given manufacturer and not by a counterfeiter, the screen protector is exposed to ultraviolet light. If present, the ultraviolet ink fluoresces. The fluorescence or more particularly fluorescence in a particular logo can be used to confirm that the screen protector was made by the alleged maker.

One-way printing can be included in the printed layer of the screen protector to provide a screen protector that can decorate a screen when powered off and not obstruct a screen when the screen is powered on. One way printing utilizes materials that are partially permeable to light and partially reflective to light. Suitable materials for one way printing are thin layers of metal, particularly, aluminum. The one-way printing works to reflect ambient light in the area of the one-way printing when the level of light of the screen is less than the ambient level of light. The one-way printing transmits light from the screen when the level of light of the screen is greater than the level of ambient light. So, when the screen is powered off and dark, the one-way printing in the screen protector is visible. When the screen is powered on and is bright, the one-way printing cannot be seen by a user and the illuminated screen is visible.

Other features of the invention are set forth in the appended claims.

Although the invention is illustrated and described herein as embodied, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an exploded isometric front side view of a screen protector with adhered print according to the invention.

FIG. 2 is a rear side view of the screen protector shown in FIG. 1.

FIG. 3 is a rear side view of a first embodiment of a first layer used in the screen protector shown in FIG. 1.

FIG. 4 is a bottom side view of the first layer shown in FIG. 3.

FIG. 5 is a rear side view of a second embodiment of the first layer used in the screen protector shown in FIG. 1.

FIG. 6 is a bottom side view of the second embodiment of the first layer shown in FIG. 6.

FIG. 7 is a partial diagrammatic and partial schematic exploded view of a screen protector with a printed logo, notably the logo printing layer is shown schematically.

FIG. 8 is a front side view of a screen protector with ultraviolet-visible ink printing while being exposed to ultraviolet light.

FIG. 9 is a front side view of the screen protector in FIG. 8 while not being exposed to ultraviolet light.

FIG. 10 is a front side view of a screen protector with a one-way printing installed on a display of a mobile electronic device when the display is not illuminated.

FIG. 11 is a front side view of the screen protector and the mobile electronic device shown in FIG. 10 when the display is illuminated.

FIG. 12 is a diagrammatic side view of an OCA layer/PET layer/logo printing layer laminate used in a screen protector like that shown in FIG. 7.

### DETAILED DESCRIPTION OF THE INVENTION

Embodiments of the invention are described below and are shown in the figures of the drawing.

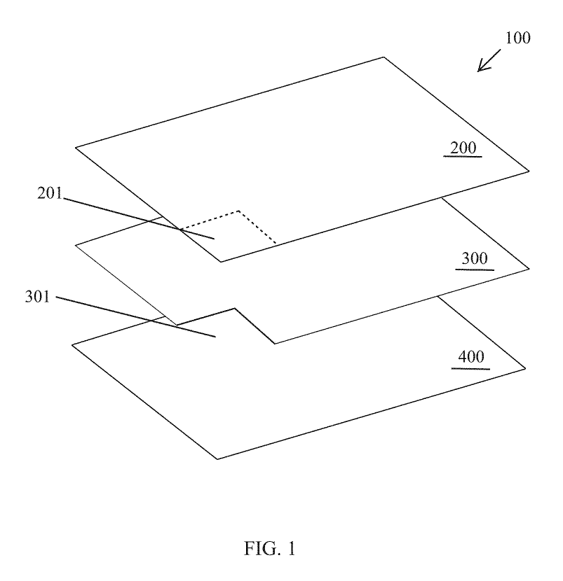

FIG. 1 shows a preferred embodiment printable glass 100 according to the present invention. The printable glass 100 is composed of various layers: glass pane 200, first layer 300, and second layer 400. The first layer 300 is preferably composed of Optically Clear Adhesive. The second layer 400 may be composed of Polyethylene Terephthalate (PET). The glass pane 200 has a logo print area 201 located on the back of the glass pane 200. The first layer 300 is placed over the interior of the glass pane 200 and the logo print area 201. The second layer 400 is placed over the first layer 300. In one embodiment, shown in FIGS. 1-4, the first layer 300 includes a space for the logo 301. In a second embodiment, shown in FIGS. 5-6, the first layer 300 does not include a space for the logo 301. The combination of the glass pane 200, the first layer 300, and the second layer 400 comprise the printable glass 100.

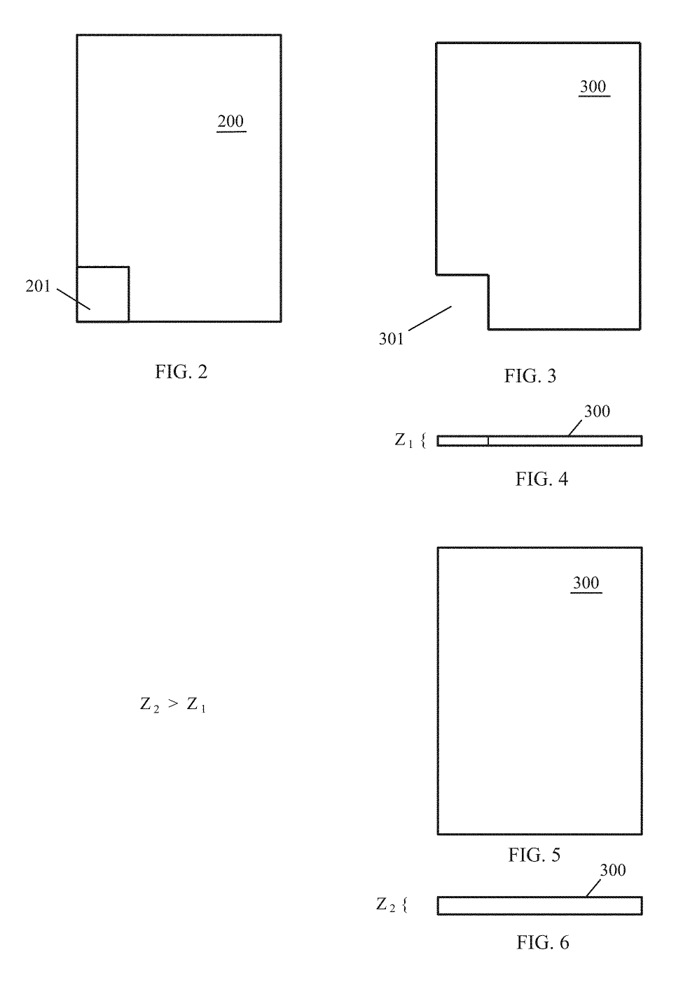

FIG. 2 shows the back of the glass pane 200. The glass pane 200 includes the logo print area 201. The glass pane 200 includes the top layer of the printable glass 100 (shown in FIG. 1).

FIG. 3 shows the first layer 300. The first layer 300 includes a space for the logo 301 in one embodiment. The first layer 300 includes the layer of the printable glass 100 behind the glass pane 200 (shown in FIG. 1).

FIG. 4 shows a cross-sectional view of the first layer 300 according to one embodiment of the present invention. The first layer 300 has a height of one embodiment Z₁. In the embodiment shown in FIG. 3 and FIG. 4, the first layer 300 provides a space for a logo 301.

FIG. 5 shows the first layer 300 according to a second embodiment of the present invention. The first layer 300 does not include a space for a logo 301 (shown in FIG. 3). The first layer 300 comprises the layer of the printable glass 100 behind the glass pane 200 (shown in FIG. 1).

FIG. 6 shows a cross-sectional view of the first layer 300 according to the second embodiment of the present invention. The first layer 300 has a height of the second embodiment Z₂. In the embodiment shown in FIG. 5 and FIG. 6, the first layer 300 does not provide a space for a logo 301 (as shown in FIG. 3). The height of the second embodiment Z₂ is greater than the height of the first embodiment Z₁ (as shown in FIG. 4). The height of the second embodiment Z₂ is greater than the height of the first embodiment Z₁ in order to replace the need for the space for the logo 301 (as shown in FIG. 3).

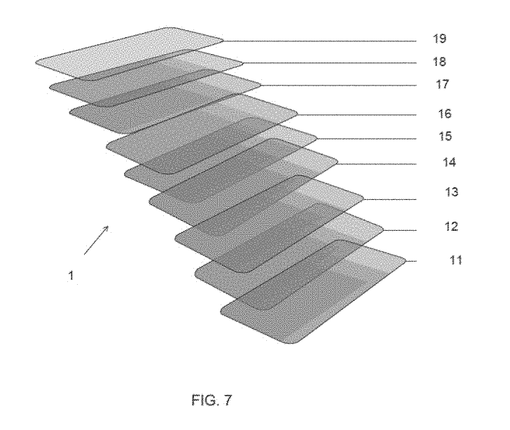

FIG. 7 shows a nine-layer embodiment of a screen protector 1. The screen protector 1 includes the following nine layers, which are listed from inner (i.e. closer to the display to be protected after installation) to outer (i.e. farther from the display to be protected after installation): protective film 11, silicon layer 12, PET layer 13, OCA layer 14, Logo Printing Layer 15, PET Layer 16, OCA layer 17, glass 18, and anti-fingerprint layer 19.

A protective film 11 is added to the interior. A preferred embodiment of the protective film 11 is a sheet of polyethylene terephthalate covering the silicon layer 12. The protective film 11 prevents the silicon layer 12 from adhering to objects other than a display before the screen protector 1 is to be installed. The protective film 11 is peeled from the silicon layer 12 immediately before the silicon layer 12 is applied to a display screen. The protective film 11 can be discarded after being peeled from the silicon layer 12.

A silicon layer 12 is disposed on an outer surface of the protective film 11. The silicon layer 12 adheres the screen protector 1 to an outer surface of a screen that is to be protected.

A PET layer 13 is made from polyethylene terephthalate. The PET layer 13 is adhered to an outer surface of the silicon layer 12. The PET layer 13 is 0.03 mm thick.

An OCA layer 14 is disposed on the PET layer 13. The OCA layer 14 is an optically-clear adhesive layer. The OCA layer 14 is preferably 0.01 mm thick. The OCA layer 14 adheres the logo printing layer 15 to the PET layer 13. The OCA layer 14 is adhered to an outer surface of the PET layer 13.

In a preferred embodiment, the PET layer 13 is purchased from a supplier with the OCA layer 14 already applied to an outer surface of the PET layer 13.

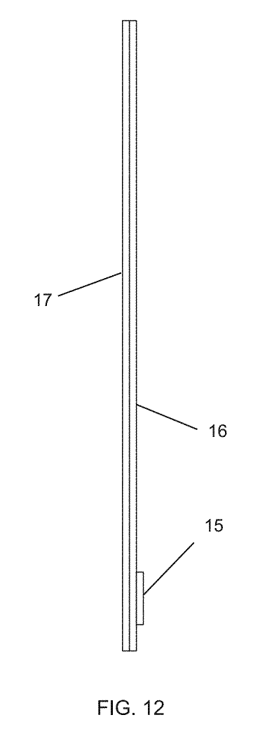

A logo printing layer 15 is disposed on the OCA layer 14. The logo printing layer 15 is as thin as possible while still providing coverage. The logo printing layer 15 is 0.02-0.03 mm thick. The logo printing layer 15 preferably utilizes environmental-friendly ink. The ink automatically cures within five (5)-seconds of application at room temperature. The size and position of logo or logos is limited by the need not to block the underlying display. FIG. 12 shows a preferred embodiment of a PET layer 16/OCA Layer 17/logo printing layer 15.

A PET layer 16 is disposed on the logo printing layer 15. The PET layer 16 is made from polyethylene terephthalate. Polyethylene terephthalate is a suitable material because polyethylene terephthalate is thin and clear. The PET layer 16 is 0.03 mm thick.

An OCA layer 17 is disposed on the PET layer 16. The OCA layer 17 is an optically-clear adhesive layer. The OCA layer 17 is preferably 0.01 mm thick. The OCA layer 17 adheres the glass 18 to the PET layer 16. The OCA layer 17 is adhered to the PET layer 16 when the PET layer is purchased from a supplier.

The OCA layers 14 and 17 are preferably made from an optically transparent resin. Preferred resins include acrylic resins. The OCA layers 14 and 17 are optically clear. In a preferred embodiment, the OCA layers 14 and 17 are each 0.01 mm thick.

Glass 18, also referred to as glass layer 18, is made from tempered glass. The glass layer 18 is disposed on the outer surface of the PET layer 16. The glass layer 18 is preferably 0.33 mm thick.

An anti-fingerprint layer 19 is disposed on the outer surface of the glass layer 18. Without the anti-fingerprint layer 19, fingerprints accumulate on the outer surface of the glass layer 18.

A preferred method of making the screen protector 1 shown in FIG. 7 includes the following steps. Before starting, the PET layers 13 and 16 are purchased with an OCA layer 14 and 17 adhered to the PET layers 13 and 16, respectively. The PET layer/OCA layer is purchased as a sheet from the supplier. The PET layer/OCA layer pieces are stamped from the sheet using a die cutting machine. The stamped piece has a surface shaped like the glass layer 18. A first step is coating an outer surface of the glass layer 18 with anti-fingerprint oil to form the anti-fingerprint layer 19. Next, a logo is printed on an inner surface of the PET layer 16. A printing press is used to print the logos. The next step is cutting finished logo printed film to match the glass layer 18. The next step is adhering the PET layer 16 to the glass layer 18 with the OCA layer 17. The next step is adhering the PET layer 13 to the logo printing layer 15 with the OCA layer 14. Lastly, an outer surface of the silicon layer 12 is applied to an inner layer of the PET layer 13. An inner surface of the silicon layer 12 has a protective film 11 attached. The layers 11-19 run through a laminating machine which presses the layers together into the screen protector 1.

The method of manufacturing the screen protector 1 is under standard lab conditions (i.e. temperature and pressure) unless otherwise noted.

To use the screen protector 1 shown in FIG. 7, a display of a device to be protected is cleaned to remove fingerprints and materials that could interfere with adhesion or cause air bubbles. In the next step, the protective film 11 is peeled from the silicon layer 12. The inner surface of the silicon layer 12 is placed on the display to be protected.

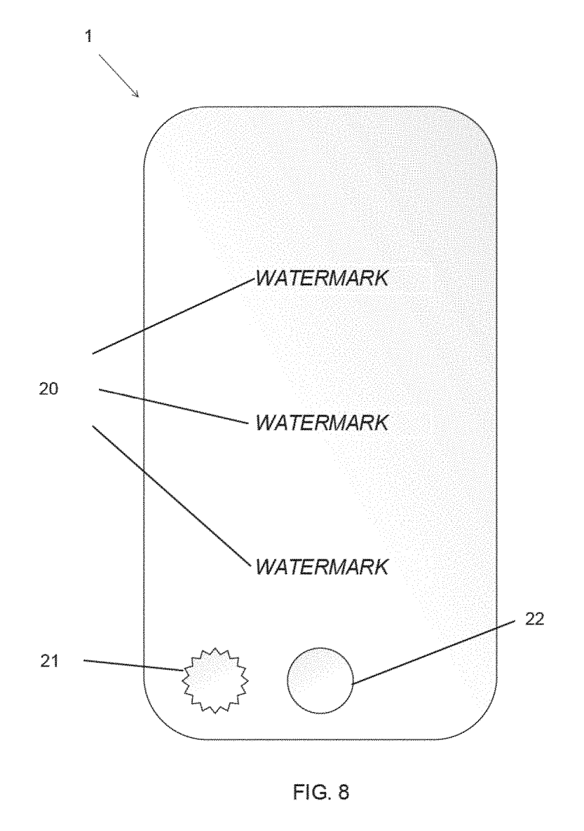

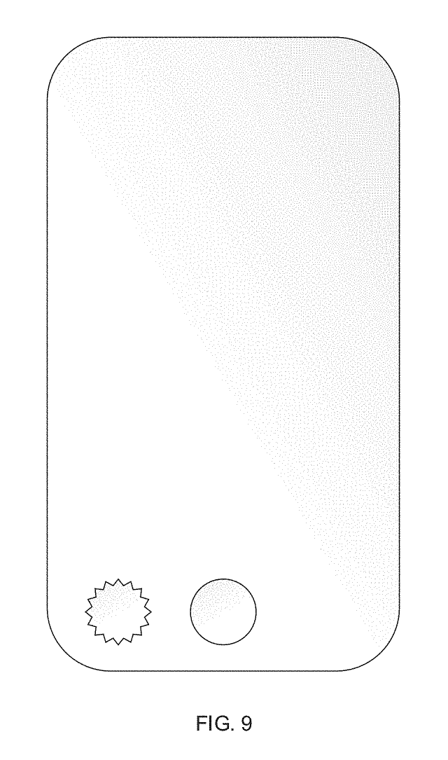

FIGS. 8-9 show a preferred embodiment of a screen protector 1 with ultraviolet visible ink printing 20. Ultraviolet visible ink is printed on the inner surface of the PET layer 16. The ultra-violet visible ink fluoresces when exposed to ultraviolet light. When the ultraviolet ink is not exposed to ultraviolet light, the ultraviolet visible ink printing 20 is not visible.

A preferred embodiment of a method for authenticating a screen protector 1 that includes ultraviolet printing 20 includes the following steps. The first step is exposing the screen protector 1 with ultraviolet light. The next step is observing for fluorescence while the screen protector 1 is being exposed to the ultraviolet light. An absence of fluorescence indicates that the screen protector 1 is counterfeit.

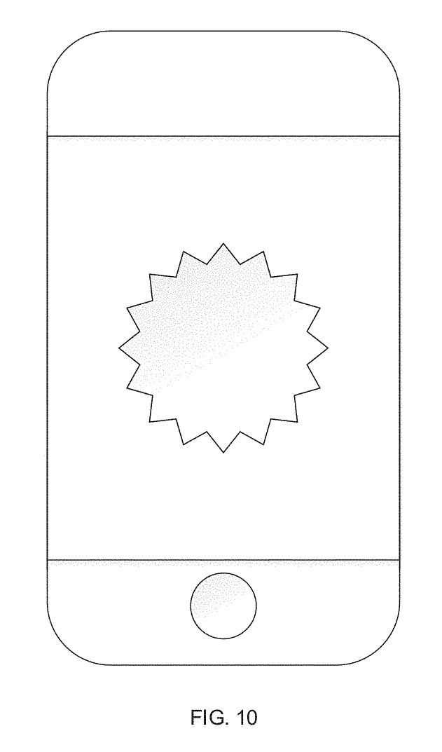

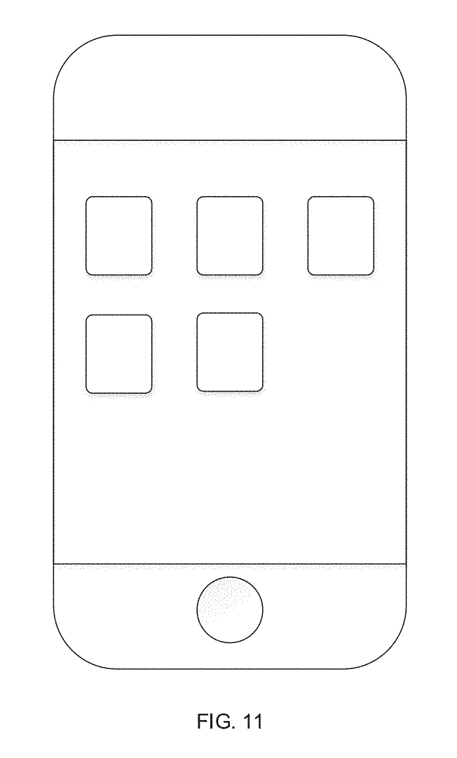

FIGS. 10-11 show a preferred embodiment of a screen protector 1 with a one-way printing 23. The one-way printing 23 is a layer of metal that is partially reflective and partially transparent to light. The one-way printing 23 is printed on an inner surface of the PET layer 16. In a preferred embodiment, the one-way printing 23 is a thin layer of aluminum. FIG. 10 shows a screen protector 1 that is installed over a screen of a mobile telephone; the screen is powered off and is not illuminated. When the ambient light level is greater than the light level of the screen, the one-way printing 23 is visible to a user. When the screen is powered on and the light level of the screen is greater than the ambient light level, then the one-way printing 23 is not visible and the screen is visible as is shown in FIG. 11.

Unless otherwise mentioned the reference numbers are used consistently throughout the figures.

What is claimed is:

1. A glass screen protector for protecting a screen of an electronic device comprising:
a glass having a back;
a logo printed on the back of the glass;
a first layer located on the back of the glass;
a second layer for contacting the screen located on the back of the first layer; and
said first layer adhering said glass to said second layer.

2. The glass screen protector for protecting a screen of an electronic device according to claim 1, wherein said first layer is an optically clear adhesive.

3. The glass screen protector for protecting a screen of an electronic device according to claim 1, wherein said second layer is a polyethylene terephthalate sheet.

4. The glass screen protector for protecting a screen of an electronic device according to claim 1, wherein the first layer is thick enough to cover a depth of said logo.

5. The glass screen protector for protecting a screen of an electronic device according to claim 1, wherein the first layer includes a space for receiving said logo.

6. A method of applying a decorative logo onto a glass pane, comprising:
tempering a glass pane;
printing a decorative logo on the back of said glass pane;
applying an optically clear adhesive layer over both the decorative logo and the back of said glass pane; and
applying a polyethylene terephthalate layer over the optically clear adhesive.

7. The method in claim 6, wherein the optically clear adhesive layer is thick enough to cover a depth of said logo.

8. The method of claim 6, wherein the Optically Clear Adhesive layer includes a space for said logo.

9. A screen protector for displaying a printed message over a screen of an electronic device being protected, comprising:
a protective film being configured to be removed before attachment;
a silicon layer for adhering to the screen after said protective film is removed, said silicon layer being disposed on said protective film;
a first polyethylene terephthalate layer being disposed on said silicon layer;
a first optically clear adhesive layer being disposed on said first polyethylene terephthalate layer;
a second polyethylene terephthalate layer being disposed on said first optically clear adhesive layer;
a logo printing layer being disposed between said first optically clear adhesive layer and said second polyethylene terephthalate layer;
a second optically clear adhesive layer being disposed on said second polyethylene terephthalate layer;
a glass layer being disposed on said second optically clear adhesive layer; and
an anti-fingerprint layer being disposed on said glass layer.

10. The screen protector according to claim 9, wherein said logo printing layer includes ultraviolet visible ink, said ultraviolet visible ink fluorescing when being exposed to ultraviolet light.

11. The screen protector according to claim 9, wherein said logo printing layer includes a one-way printing.

12. The screen protector according to claim 11, wherein said logo printing layer is partially permeable to light and partially reflective to light.

13. The screen protector according to claim 12, wherein said logo printing layer includes a layer of aluminum.

14. A method for authenticating a manufacturer of a screen protector, which comprises:
Illuminating a screen protector with ultraviolet light, said screen protector having a glass layer, ultraviolet visible ink being disposed on said glass layer, and adhesive being disposed on said glass layer and said ultraviolet visible link; and
detecting fluorescence from the ultraviolet visible ink when said ultraviolet visible ink is being exposed to the ultraviolet light.

15. A method for decorating a screen with a screen protector while the screen is powered off and allowing the screen to be read when the screen is powered on, which comprises:
applying, to a wireless device with a screen, a screen protector having a glass layer, a one way printing being disposed on said glass layer, and adhesive being disposed on said glass layer and said one-way printing, said one-way printing being configured to be partially permeable to light from a display to be protected when the display is powered on, and said one-way printing being configured to be partially reflective of ambient light when the display is powered off;
obstructing at least a portion of said screen with said one-way printing when said screen is powered off; and
observing said screen through said one-way printing when said screen is powered on.
